(19) United States
(12) Patent Application Publication
(10) Pub. No.: US 2026/0355702 A1
(43) Pub. Date: Nov. 12, 2026

(54) A METHOD AND DEVICE FOR AERATING AN ALCHOHOLIC BEVERAGE

(71) Applicant: VINALCHEMY LIMITED, Colchester (GB)

(72) Inventor: Michael William PRITCHARD, Colchester (GB)

(21) Appl. No.: 19/125,723

(22) PCT Filed: Oct. 30, 2023
(86) PCT No.: PCT/GB2023/052820

§ 371 Date: Apr. 29, 2025

(30) Foreign Application Priority Data
Nov. 3, 2022 (GB) 2216383.6

(51) Int. Cl. B01F 23/2361; B01F 23/23; B01F 23/231; B01F 23/237; B01F 101/17

(52) U.S. Cl. CPC B01F 23/2361; B01F 23/23123; B01F 23/23125; B01F 23/2366; B01F 23/237611; B01F 2101/17

(57) ABSTRACT

A kit for aerating an alcoholic beverage comprises a gas diffuser and a pressurised source of vitiated air adapted to be coupled to the gas diffuser for introducing bubbles of vitiated air when the gas diffuser is immersed within a body of the alcoholic beverage. In preferred embodiments, the source of vitiated air is an aerosol containing air compressed using nitrogen gas so that there is substantially no more than 10% by volume of oxygen. Suitable beverages include wine and spirits.

### BACKGROUND TO THE INVENTION

Aerating wine simply means exposing the wine to air or giving it a chance to “breathe” before drinking it. The reaction between gases in the air and wine is known to change the flavour of the wine. Aerating wine can help disperse some of the unpleasant odours, typically associated with volatile ethanol and sulphur compounds in the wine, making the wine smell better. Importantly, aerating the wine causes a degree of oxidation because of a chemical reaction between certain molecules in the wine and oxygen in the air. This reaction occurs naturally during winemaking, even after it has been bottled. Compounds in wine which are susceptible to oxidation include catechins, anthocyanins, epicatechins, and other phenolic compounds. Likewise, ethanol is susceptible to oxidation. Too much oxidation though ruins any wine. The combination of diminished flavour, aroma, mouthfeel, and colour is called “flattening”.

When you open a bottle of wine there is very little interaction with air through the narrow neck of the bottle and the wine inside. Although it is known to leave the wine in the bottle for an hour or more to breathe on its own, this is a frustratingly long time to wait before drinking, and the effect is hard to control or predict. It is generally desirable to accelerate this process to reduce the wait time. One approach to this is to pour the wine into a decanter, a container offering a much greater surface area to expose the wine to the surrounding air. Another approach is to use an aerator which either attaches to the bottle of wine or sits within the neck of a decanter and forces an interaction with air as the wine is poured. There are numerous commercially available aerators such as venturi devices which help infuse oxygen into the wine to a greater or lesser extent.

Other beverages that are known to benefit from aeration include spirits, particularly whiskey and bourbon.

### SUMMARY OF THE INVENTION

According to a first aspect of the present invention, a kit for aerating an alcoholic beverage comprises a gas diffuser and a pressurised source of vitiated air adapted to be coupled to the gas diffuser for introducing bubbles of vitiated air when the gas diffuser is immersed within a body of the alcoholic beverage.

Preferably, the kit further comprises a valve for controllably releasing vitiated air from the pressurised source.

Preferably, the source of vitiated air is a pressurised gas cylinder, preferably an aerosol can. Preferably, the gas cylinder is fitted with a dip tube.

Preferably, the source of vitiated air comprises air compressed using a gas, preferably selected from a group which includes nitrogen, carbon dioxide and argon.

Preferably, the kit further comprises a length of tubing for coupling the source of vitiated air to the diffuser. The tubing may be a food or medical grade plastics tube, a silicone tube, or a metal tube, which may be telescopic.

Preferably, the gas diffuser is formed from a porous material. Examples of suitable porous materials include a stone air diffuser and a porous sinter diffuser, preferably formed from sintered metal. In some embodiments, a plurality of gas diffusers can be used. The size and shape of the or each gas diffuser may be selected according to the size of the vessel used to hold the beverage.

Preferably, the source of vitiated air comprises substantially no more than 10% by volume of oxygen. In some embodiments, the vitiated air comprises substantially no more than 5% by volume of oxygen, more preferably in the range of 0.5% to 3%, even more preferably around 1.5%.

Preferably, the source of vitiated air is pressurised to at least 200 kPa, preferably at least 400 kPa, more preferably in the range 500 kPa to 30000 kPa, and even more preferably around 1500 kPa. The selected pressure will in part be dependent upon the type and size of container used to hold the vitiated air.

According to a second aspect of the present invention, a wine package comprises a number of bottles of wine and an aeration kit according to the first aspect of the present invention.

Preferably, the aeration kit is packaged to occupy substantially the same space and volume as a bottle of wine.

According to a third aspect of the present invention, a method for aerating an alcoholic beverage prior to drinking comprises the step of introducing a stream of bubbles of vitiated air into a body of the beverage for a period of time.

The period of time may be dependent on the volume of liquid, the shape and size of the vessel containing the beverage, the amount of oxygen in the vitiated air, and/or the type of beverage.

Preferably, the period is at least 1 second, and preferably around 3 to 5 seconds when aerating a standard 75 cl bottle of wine in a decanter.

In some embodiments, the vitiated air is dispensed from a gas container, preferably an aerosol can. In other embodiments, the vitiated air is dispensed from an aeration gun assembly adapted to entrain atmospheric air into a flow of gas from a pressurised gas supply

Preferably, the aerated beverage is left to settle before consumption to allow any surface bubbles to dissipate.

Preferably, the alcoholic beverage is a wine or a spirit.

According to a fourth aspect of the present invention, a system for aerating an alcoholic beverage comprises a pressurised source of gas that contains no more than substantially 10% by volume of oxygen, and a gas diffuser for receiving a flow of gas from the pressurised source to deliver a stream of bubbles when the gas diffuser is immersed within a body of alcoholic beverage.

In some embodiments, the source of pressurised gas is a vessel containing pressurised vitiated air, preferably an aerosol can. Preferably, the system further comprises a gas pipe having a proximal end for coupling to an outlet of an aerosol can and a distal end for coupling to the gas diffuser.

In other embodiments, the source of pressurised gas comprises a plurality of gas cylinders and at least one gas regulator to supply a flow of mixed gas containing no more than 10% by volume of oxygen.

In other embodiments, the source of pressurised gas comprises a gas cylinder pre-charged with a mix of gases.

In other embodiments, the source of pressurised gas comprises a plurality of gas cylinders and at least one gas regulator to supply a flow of mixed gas containing no more than 10% by volume of oxygen.

In other embodiments, the source of pressurised gas comprises an aeration gun assembly coupled to a gas supply, the aeration gun assembly being adapted to entrain atmospheric air into a flow of gas from the gas supply for delivery to the gas diffuser.

According a fifth aspect of the present invention, a method for removing sulfites from a body of wine comprises the step of dosing the body of wine with a stream of micro-bubbles of gas which comprises substantially no more than 10% by volume of oxygen.

The wine may be dosed with micro-bubbles of gas either during or after production to oxidise compounds in the wine which are susceptible to oxidation including catechins, anthocyanins, epicatechins, and other phenolic compounds and also sulfites.

### BRIEF DESCRIPTION OF THE DRAWINGS

Examples of the present invention will now be described in detail with reference to the accompanying drawings, in which:

FIG. 1 shows an example of an aeration kit in accordance with the present invention which includes an aerosol as a source of vitiated air for aerating an alcoholic beverage such as wine by introducing a stream of bubbles of vitiated air into a body of the wine;

FIG. 2 shows the operation of the aeration kit of FIG. 1 to aerate wine in a decanter using bubbles of vitiated air;

FIG. 3 shows an example of an aeration system in accordance with the present invention for use in aerating an alcoholic beverage;

FIG. 4 is a simplified example of a hand-held aeration gun assembly for entraining atmospheric air into a flow of pressurised gas to create a source of vitiated air for use in aerating an alcoholic beverage in accordance with the present invention; and,

FIG. 5 shows a partially cut away view of a fibreboard packaging wine shipping case holding bottles of wine and a cardboard packing tube containing an aeration kit in accordance with the present invention.

### DETAILED DESCRIPTION

It is known that dissolving oxygen into wine and other alcoholic beverages allows oxygen to react with sulfites, flavonoids and other chemicals to improve its aromas, flavours, and mouthfeel.

Wine's many tannins and monomeric anthocyanins are waiting to find each other and polymerise so as to stabilise each other. Anthocyanins cap the ends of tannin chains, sealing them, preventing further polymerisation. This polymerisation keeps both tannins and colour molecules in solution—otherwise, both types of compounds would quickly be lost.

The presence of oxygen during and postproduction significantly speeds polymerisation, as well as diversifies the ways in which tannins can bond to each other.

If wine is exposed to oxygen in the air (typically air is 21% oxygen by volume) via decanting, the oxygen dissolution is extremely limited. Oxygen has to dissolve into the wine before any reactions can take place within the wine. It can only dissolve oxygen through the exposed surface area within the decanter. This can take several hours to achieve for some wines.

Known wine aeration devices such as venturi devices do increase the effective surface area to improve aeration. However, the surface area exposed is still relatively small and the dwell time as wine passes through the device is insufficient to disperse all the unpleasant odours and affect significant polymerisation.

In this application, the term ‘vitiated air’ means air in which the oxygen content has been reduced. In some embodiments, the vitiated air comprises substantially no than 10% by volume of oxygen, preferably no more than 5%, more preferably in the range of 0.5% to 3%, even more preferably around 1.5%.

In preferred embodiments of the present invention, a method for aerating an alcoholic beverage such as wine prior to drinking includes the step of introducing a stream of micro-bubbles of vitiated air via a gas diffuser into a body of the beverage for a period of time.

In other embodiments, instead of using vitiated air, we use a gas mixture with a similarly low oxygen content to achieve the same outcome.

Without wishing to be bound by theory, the use of micro-bubbles of gas considerably increases the surface area of the wine exposed to oxygen such that the primary goals of aeration can be achieved over a short period of just a few seconds without flattening the wine. It is believed that the process is effective to reduce sulfite levels in wine through a process of oxidation to produce sulphates. Sulfites are typically added to wine to scavenge oxygen and act as preservative to extend shelf life. Many people are allergic to sulfites, with headaches being one of several reported side-effects. Finally, excess oxygen dissolved in the wine is also significantly reduced through gas sparging to moderate the amount of further oxidation that occurs.

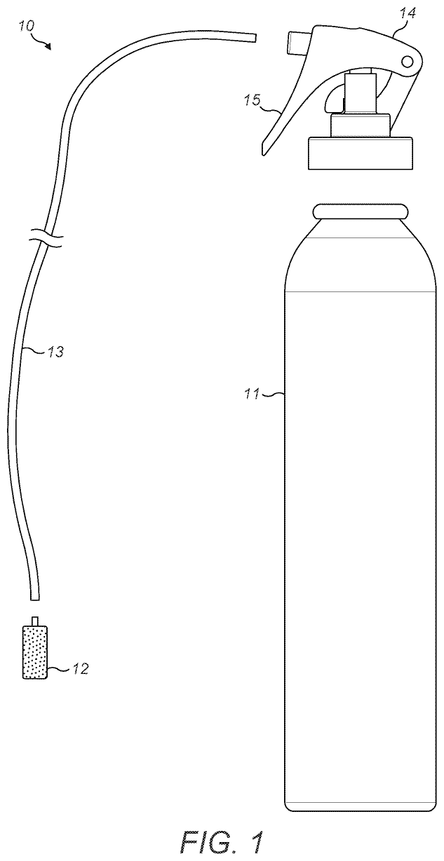

FIG. 1 shows an example of a kit 10 for aerating an alcoholic beverage, such as wine. The kit 10 comprises an aerosol can 11 filled with pressurised vitiated air, a gas diffuser 12, and a length of tubing 13 for coupling the aerosol can 11 to the gas diffuser 12. The aerosol can 11 is fitted with a valve trigger assembly 14 having a trigger 15 for controlling the release of gas from the aerosol can 11. The aerosol can 11 may also include an internal dip tube (not shown).

The length of tubing 13 may be a food or medical grade plastics tube, a silicone tube, or a metal tube, which may be telescopic.

The gas diffuser 12 is formed from a porous material, for example a stone air diffuser or a porous sinter diffuser, which may be formed from a sintered metal. The function of the gas diffuser 12 is to introduce a stream of micro-bubbles of vitiated air into the wine or other alcoholic beverage. In some embodiments it may be useful to employ several gas diffusers coupled to the same source of gas.

In preferred embodiments, the vitiated air comprises air compressed using nitrogen as part of an aerosol can filling process. Other similarly inert gases such as argon can be used instead of, or in addition to, nitrogen. In a particularly preferred embodiment, the aerosol contains around 1.5% of oxygen by volume at a pressure of 1500 kPa.

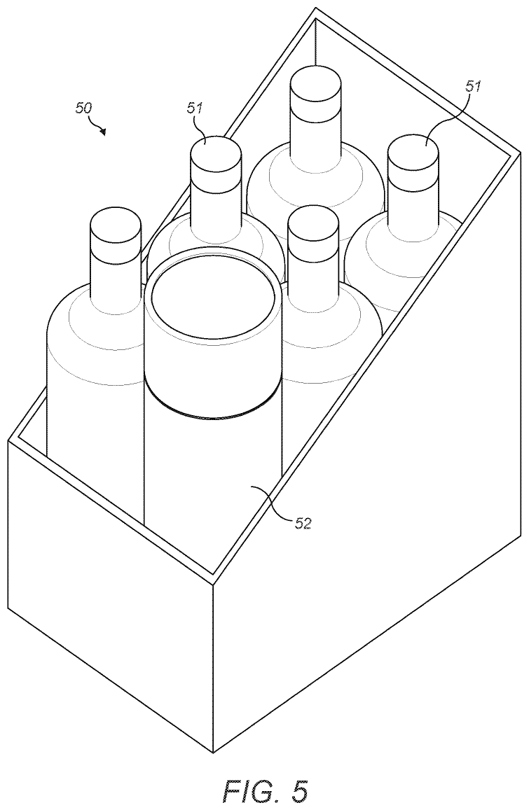

Advantageously, the kit 10 of FIG. 1 can be packaged within a cylindrical packaging box for placement within a fibreboard packaging case of wine (see FIG. 5), occupying substantially the same volume as a bottle of wine would.

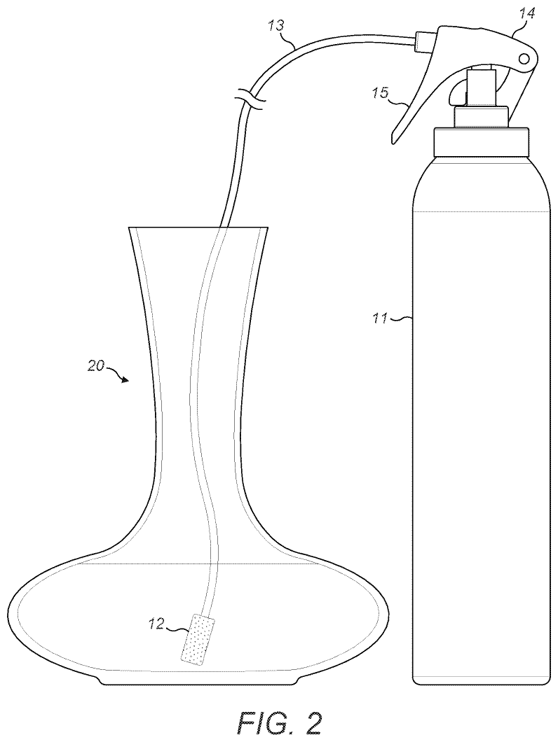

FIG. 2 shows the assembled kit of FIG. 1 with the gas diffuser 12 inserted by a user into a wine decanter 20 holding the contents of a bottle of wine. When the user pulls the trigger 15, vitiated air flows from the aerosol can 11 to the gas diffuser 12 via the tubing 13 where it is released as a stream of micro-bubbles into the body of wine. It is desirable to locate the gas diffuser 12 towards the bottom of the decanter 20 to ensure the entire contents are exposed to the bubbles. A dosage of around 3 to 5 seconds is typically sufficient to aerate a bottle of wine, but it may be necessary to dose for a shorter or longer period than this dependent on the volume of wine, the type and/or age of the wine, and the percentage of oxygen in the vitiated air.

Although purely for aesthetic reasons, it may be preferable to leave the aerated wine for a minute or two after the user has removed the tubing 13 and gas diffuser 12 to allow any surface bubbles to disperse before serving the wine.

Although we show the wine in a decanter 20 in FIG. 2, it is also possible to aerate the wine in its bottle, in a wine glass, or any other suitable container.

After aerating the wine, the tubing 13 and gas diffuser 12 can be cleaned in water to remove residual wine and left to dry.

The dosage of micro-bubbles ensure that several key elements of wine aeration are achieved, namely the dispersion of unpleasant odours typically associated with a newly opened bottle of wine, the oxidation of various chemicals in the wine to improve flavour and mouth feel, the reduction of sulfites and sparging (removal) of excess free oxygen to prevent subsequent flattening of the wine through over oxidation. This process greatly accelerates the aeration of wine without overdosing the wine with oxygen, which would otherwise prematurely flatten the wine.

In a series of tests using the device of FIG. 2 and a commercially available oxygen saturation meter (Hanna Instruments, Optical Dissolved Oxygen Meter, Model HI98198), we measured the levels of dissolved oxygen within a decanter holding a 75 cl bottle of red wine after dosing the wine in the decanter for approximately 5 seconds with a stream of micro-bubbles of gas containing oxygen at the following percentages by volume—1.4%, 2.1 %, 4.2%, 6.8%, 10.5%, 21% (air), and 99.9% (pure oxygen). We compared the performance with wine that had been poured into a decanter through a commercially available venturi device and wine that had simply been poured into a decanter. After an initial reading, oxygen levels were taken at 5 minute intervals over the course of an hour.

The results showed that at levels of oxygen at 21% and 99.9% by volume, there was a considerable degree of oxygen dissolution in the wine (measured at a 600% and a 1600% increase in dissolved oxygen, respectively), which remained substantially at that level over the course of the hour. Subjectively though, the wine had flattened through over oxidisation and thereby ruined.

At 10.5% by volume of oxygen, the oxygen levels over time compared very closely to that achieved by the venturi device, namely a 300% or so increase in dissolved oxygen with insignificant further variation over the hour.

At the remaining levels below 10.5% by volume, the level of dissolved oxygen increased by between 100% and 140%, also with insignificant further variation over the hour.

When using the aeration device of the present invention, at oxygen levels of 10.5% and below, we observed that the wine had significantly improved aroma, mouthfeel and taste characteristics immediately after dosing the wine, suggesting that the core goals of wine aeration mentioned above were achieved far more quickly than through decanting the wine or using the venturi device, and without leaving excess oxygen in solution.

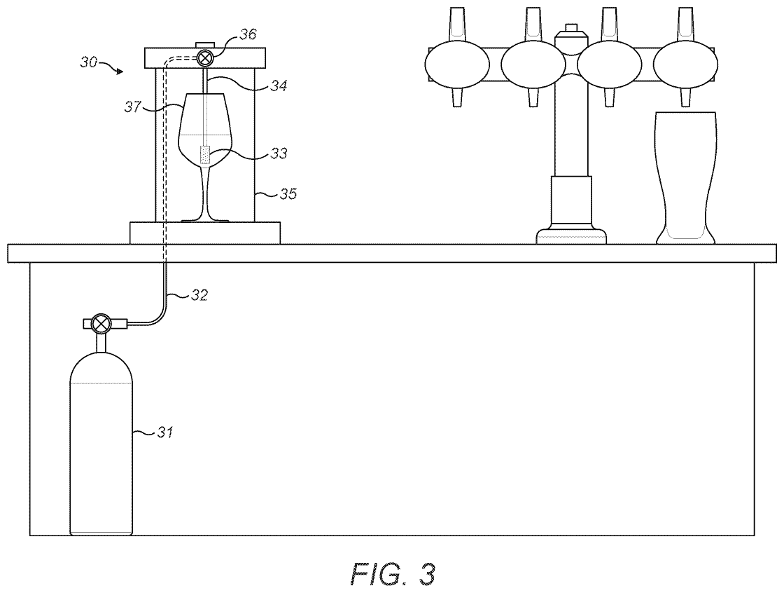

FIG. 3 shows an example of a bench mounted wine aeration system 30 for use in a commercial bar setting which uses the same principle of operation. Instead of an aerosol can, the system includes a gas cylinder 31 filled with a pressurised gas mixture that includes no more than around 10% of oxygen under pressure, preferably no more than 5%, more preferably in the range of 0.5% to 3%, even more preferably around 1.5%. The gas can be vitiated air, or a mixture of gases including oxygen introduced during filling. The gas cylinder is coupled using gas tubing 32 to a gas diffuser 33 mounted at one end of a hollow lance 34. A bench mounted housing 35, which includes a button actuated valve 36 for controllably releasing gas from the gas cylinder 31 to the gas diffuser 33, is provided to receive a glass of wine 37.

In this arrangement, a glass of wine 37 or other alcoholic beverage is presented by a user to the gas diffuser 33 so that the gas diffuser 33 sits towards the bottom of the glass 37 and then gas is released from the gas cylinder 31 by operation of the valve 36 to aerate the wine in the manner described above.

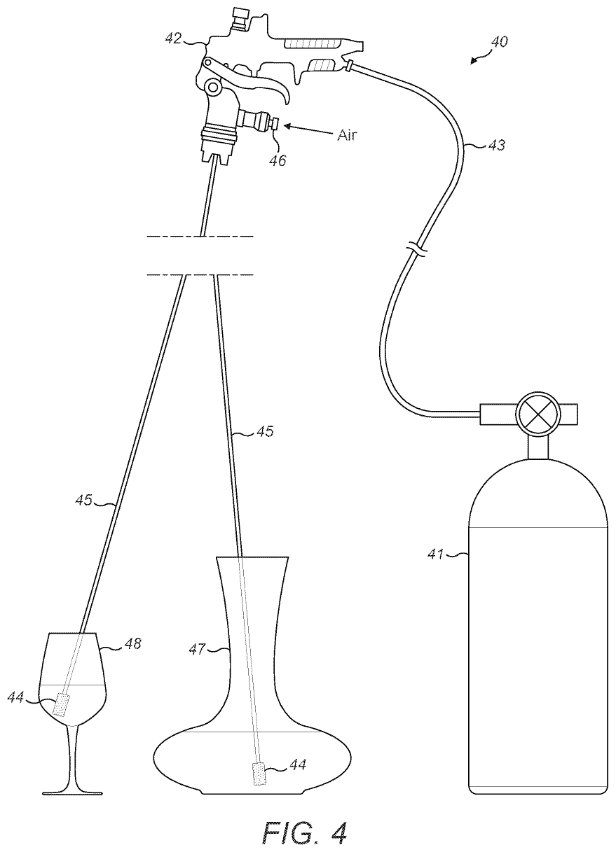

FIG. 4 shows another example of a wine aeration system 40 which includes a gas cylinder 41 filled with a pressurised gas such as nitrogen, coupled to an aeration trigger assembly 42 via a length of gas tubing 43. The aeration trigger assembly 42 includes a gas diffuser 44 coupled to a distal end of a hollow lance 45. The aeration trigger assembly 42 includes an orifice 46 which communicates with an internal fluid conduit (not shown) which carries gas from the gas cylinder 41 to the proximal end of the lance 45 and thereby to the gas diffuser 44 at the distal end of the lance 45.

In operation, when the aeration trigger assembly 42 is actuated by a user, a flow of nitrogen gas from the gas cylinder 41 entrains a flow of atmospheric air via the orifice 46 into the fluid conduit to form a flow of vitiated air which travels to the gas diffuser 44. In this manner, a hand-held aeration trigger can be used to aerate wine in a decanter 47, a wine glass 48 or other suitable container, in the same manner as described above.

FIG. 5 shows a partially cut away view of a fibreboard wine shipping case 50 holding 5 bottles of wine 51, and a cardboard packing tube 52 containing the aeration kit 10 described above with reference to FIG. 1. The cardboard packing tube 52 is designed to occupy substantially the same space as a bottle of wine 51 and so conveniently can be packaged and shipped with wine in the normal manner.

Although much of the description above relates to the aeration of wine, the same process and systems can be used to aerate other alcoholic beverages such as spirits, especially whiskey and bourbon.

It is envisaged that the source of gas for aerating the beverage can be formed from a group of gas cylinders coupled together via a regulator to achieve the desired mix of gases with a low oxygen content. Additionally, the source of gas can be premixed during a factory-based filling process or be mixed on site, for example at a bar or restaurant.

1-25. (canceled)

26. A kit for aerating a beverage comprising a gas diffuser and a pressurised source of an aeration gas comprising between 0.5% and 10% by volume of oxygen, the pressurised source being adapted to be coupled to the gas diffuser for introducing bubbles of aeration gas when the gas diffuser is immersed within a body of the beverage, wherein the aeration gas comprises air mixed with an inert gas.

27. A kit according to claim 26, further comprising a valve for controllably releasing aeration gas from the pressurised source.

28. A kit according to claim 26, wherein the source of aeration gas is an aerosol can filled with the aeration gas.

29. A kit according to claim 28, wherein the aerosol can is fitted with a dip tube.

30. A kit according to claim 26, wherein the inert gas is selected from a group which includes nitrogen, carbon dioxide and argon.

31. A kit according to claim 26, further comprising a length of tubing for coupling the source of aeration gas to the gas diffuser.

32. A kit according to claim 31, in which the tubing is one of a food grade plastics tube, a medical grade plastics tube, a silicone tube, or a metal tube.

33. A kit according to claim 26, wherein the gas diffuser is formed from a porous material.

34. A kit according to claim 26, in which the gas diffuser is one of a stone air diffuser or a porous sinter diffuser.

35. A kit according to claim 26, wherein the source of aeration gas air is pressurised to at least 200 kPa, preferably at least 400 kPa, more preferably in the range 500 kPa to 30000 kPa, and even more preferably around 1500 kPa.

36. A kit according claim 26, wherein the aeration gas comprises no more than 5% by volume of oxygen, preferably between 0.5% and 3% by volume of oxygen, and more preferably around 1.5% by volume of oxygen.

37. A wine package comprising a container housing a number of bottles of wine and an aeration kit according to claim 26.

38. A wine package according to claim 37, wherein the aeration kit is packaged within the container to occupy substantially the same space and volume as a bottle of wine.

39. A method for aerating a beverage comprising the step of introducing a stream of bubbles of an aeration gas into a body of the beverage for a period of time, the aeration gas comprising air mixed and pressurised with an inert gas, and having between 0.5% and 10% by volume of oxygen.

40. A method according to claim 39, wherein the period of time is dependent on a volume of the beverage, and preferably the period is at least 1 second, and preferably around 3 to 5 seconds.

41. A method according to claim 39, wherein the aeration gas is dispensed from an aerosol can and introduced vi a gas diffuser.

42. A method according to claim 39, in which the beverage is an alcoholic beverage, preferably a wine.

43. A method according to claim 39, wherein the aeration gas comprises no more than 5% by volume of oxygen, and preferably between 0.5% and 3% by volume of oxygen, and more preferably around 1.5% by volume of oxygen.

44. A method for aerating wine comprising the step of dosing the wine using a pressurised stream of micro-bubbles of an aeration gas introduced into the wine via a gas diffuser, the aeration gas comprising oxygen mixed with an inert gas, and having between 0.5% and 5% by volume of oxygen.

45. A method according to claim 44, wherein the aeration gas comprises between 0.5% and 3% by volume of oxygen, preferably around 1.5% by volume of oxygen.
